(19) United States
(12) Patent Application Publication
(10) Pub. No.: US 2017/0257913 A1
(43) Pub. Date: Sep. 7, 2017

(54) INDUCTION BURNER COOLING SYSTEMS AND METHODS

(71) Applicant: Meyer Intellectual Properties Limited, Kowloon (HK)

(72) Inventors: Darren Erik Vengroff, Seattle, WA (US); Jonathan A. Jenkins, Seattle, WA (US)

(73) Assignee: Meyer Intellectual Properties Limited, Kowloon (HK)

(21) Appl. No.: 15/446,357

(22) Filed: Mar. 1, 2017

Related U.S. Application Data
(60) Provisional application No. 62/302,128, filed on Mar. 1, 2016.

(51) Int. Cl. H05B 6/06; H05B 6/42; H05B 6/12

(52) U.S. Cl. CPC H05B 6/062; H05B 6/1209; H05B 6/42

(57) ABSTRACT

According to one embodiment, a portable induction cooking device includes a housing having a top platen surface, a bottom wall, and a sidewall defining an interior space. The interior space includes a first portion and a second portion. The device further includes an intake including one or more openings extending through the sidewall, and a vent including one or more openings extending through the sidewall. The device also includes one or more fans that each include a first inlet that draws air into the fan from the first portion, and a first outlet that discharges air out of the fan into the second portion. The one or more fans are configured to draw air into the housing through the intake in a first generally horizontal direction and are further configured to discharge air out of the housing through the vent in a second generally horizontal direction.

### CROSS-REFERENCE TO RELATED APPLICATIONS

This application claims priority to U.S. Provisional Patent Application No. 62/302,128 filed Mar. 1, 2016, the entirety of which is incorporated herein by reference.

### TECHNICAL FIELD

The present disclosure relates to cooling systems for induction cooking devices. More specifically, the present disclosure relates to cooling systems for induction cooking devices comprising fans.

### SUMMARY

A first aspect of the invention includes a portable induction cooking device, the device comprising: a generally cylindrical housing having a generally circular top platen surface for supporting a cooking vessel, a bottom wall, and a sidewall defining an interior space, wherein the interior space comprises a first portion and a second portion of the interior space separated by one or more baffles; the second portion of the interior space being disposed adjacent to the first portion of the interior space, wherein the platen surface extends over the first and second portions of the interior space; the sidewall comprising a first portion extending along the first portion of the interior space and a second portion extending along the second portion of the interior space; an intake comprising one or more openings extending through the first portion of the sidewall between the first portion of the interior space and an external environment; a vent comprising one or more openings extending through the second portion of the sidewall between the second portion of the interior space and the external environment; one or more fans positioned in the interior space, wherein each of the one or more fans includes an inlet positioned in the first portion of the interior space and an outlet positioned in the second portion of the interior space, wherein the inlet draws air into the fan in a first generally vertical direction, wherein the outlet discharges air out of the fan in a first generally horizontal direction, wherein the one or more fans are configured to draw air into the housing through the intake in a second generally horizontal direction and are further configured to discharge air out of the housing through the vent in a third generally horizontal direction; at least one induction coil disposed below the platen surface; electronics for modulating the power of the at least one induction coil, the electronics being positioned in the second portion of the interior space, at least a portion of the electronics being thermally connected to a heat sink having a series of vertical fins that define channels, the channels being positioned approximately parallel to the air discharged from the respective outlet of at least one of the one or more fans, the heat sink being positioned adjacent to the respective outlet of the at least one of the one or more fans; and wherein the device weighs less than 15 pounds.

A second aspect of the invention includes a portable induction cooking device, the device comprising: a housing having a top platen surface for supporting a cooking vessel, a bottom wall, and a sidewall defining an interior space, wherein the interior space comprises a first portion and a second portion of the interior space separated by one or more baffles; an intake comprising one or more openings extending through the sidewall between the first portion of the interior space and an external environment; a vent comprising one or more openings extending through the sidewall between the second portion of the interior space and the external environment; one or more fans positioned in the interior space, wherein each of the one or more fans includes a first inlet positioned in the first portion of the interior space and a first outlet positioned in the second portion of the interior space, wherein the first inlet draws air into the fan from the first portion of the interior space and the first outlet discharges air out of the fan into the second portion of the interior space, wherein the one or more fans are configured to draw air into the housing through the intake in a first generally horizontal direction and are further configured to discharge air out of the housing through the vent in a second generally horizontal direction; at least one induction coil disposed below the platen surface; and electronics for modulating the power of the at least one induction coil, the electronics being positioned in the second portion of the interior space.

Another aspect of the invention is any such system, wherein the device weighs less than 15 pounds.

Another aspect of the invention is any such system, wherein the device weighs less than 5 pounds.

Another aspect of the invention is any such system, wherein the first inlet of each of the one or more fans draws air into the fan in a generally vertical direction.

Another aspect of the invention is any such system, wherein the first inlet of each of the one or more fans draws air into the fan in a third generally horizontal direction.

Another aspect of the invention is any such system, wherein each of the one or more fans further includes a second inlet positioned in the first portion of the interior space, wherein the first inlet is positioned on a top wall of the respective fan and draws air into the respective fan in a first generally vertical direction, wherein the second inlet is positioned on a bottom wall of the respective fan and draws air into the respective fan in a second generally vertical direction.

Another aspect of the invention is any such system, wherein the first outlet of each of the one or more fans is positioned on a sidewall of the respective fan and discharges air out of the respective fan in a third generally horizontal direction.

Another aspect of the invention is any such system, wherein at least a portion of the electronics are thermally connected to a heat sink.

Another aspect of the invention is any such system, wherein the heat sink has a series of vertical fins that define channels, the channels being positioned approximately parallel to the air discharged from the first outlet of at least one of the one or more fans.

Another aspect of the invention is any such system, wherein the heat sink is positioned adjacent to the first outlet of the at least one of the one or more fans.

Another aspect of the invention is any such system, wherein the housing has a cross-sectional shape that is generally circular, generally rectangular, generally oval, or generally square.

Another aspect of the invention is any such system, wherein the vent is positioned on the sidewall in a location that is opposite of a location of the intake.

Another aspect of the invention is any such system, wherein the size of the intake is at least 30% of the size of a combination of the first inlet and any other inlet of a respective fan of the one or more fans.

Another aspect of the invention is any such system, wherein the size of the intake is at least 45% of the size of a combination of the first inlet and any other inlet of a respective fan of the one or more fans.

A third aspect of the invention includes a method of cooling a portable induction cooking device, the portable induction cooking device comprising a housing that defines an interior space separated into a first portion and a second portion, wherein the first portion includes one or more intake openings extending through a sidewall of the housing and a first inlet of each of one or more fans, and wherein the second portion includes one or more vent openings extending through the sidewall of the housing and a first outlet of each of the one or more fans, the method comprising: drawing airflow into the first portion through the one or more intake openings in a first generally horizontal direction; drawing airflow into each of the one or more fans through the respective first inlet in a first generally vertical direction; discharging airflow into the second portion out of each of the one or more fans through the respective first outlet in a second generally horizontal direction, and cooling electronics for modulating an induction coil of the portable induction cooking device using at least a portion of the airflow discharged into the second portion; and further discharging airflow out of the second portion through the one or more vent openings in a third generally horizontal direction.

Another aspect of the invention is any such method, wherein cooling the electronics comprises passing the airflow discharged into the second portion over at least a portion of a heat sink thermally connected to a portion of the electronics.

Another aspect of the invention is any such method, wherein each of the one or more fans further includes a second inlet, and wherein the method further comprises drawing airflow into each of the one or more fans through the respective second inlet in a second generally vertical direction.

Another aspect of the invention is any such method, wherein the portable induction cooking device weighs less than 15 pounds.

Another aspect of the invention is any such method, wherein the portable induction cooking device weighs less than 5 pounds.

### BRIEF DESCRIPTION OF THE FIGURES

For a more complete understanding of the present disclosure and its features and advantages, reference is now made to the following description, taken in conjunction with the accompanying drawings, in which:

FIG. 1 schematically illustrates a side view of an example induction cooking device having a cooling system according to various embodiments described herein;

FIG. 2 schematically illustrates a side view of another example induction cooking device having a cooling system according to various embodiments described herein;

FIG. 3 schematically illustrates a side view of another example induction cooking device having a cooling system according to various embodiments described herein;

FIG. 4 schematically illustrates a side view of another example induction cooking device having a cooling system according to various embodiments described herein;

FIG. 5 is an elevated front view of an example induction cooking device having a cooling system according to various embodiments described herein;

FIG. 6 is an exploded view of the induction cooking device of FIG. 5 according to various embodiments described herein;

FIG. 7 is cross-sectional side view of the induction cooking device of FIG. 5 taken along line 7-7 of FIG. 5 according to various embodiments described herein;

FIG. 8 is a cross-sectional top view of the induction cooking device of FIG. 5 taken along line 8-8 of FIG. 5;

FIG. 9A is a schematic illustration of the induction cooking device of FIG. 5 having an example heat sink for cooling control/power electronics;

FIG. 9B is a schematic illustration of a back view of the heat sink of FIG. 9A;

FIG. 10A is a schematic illustration of the induction cooking device of FIG. 5 having example heat sinks for cooling control/power electronics;

FIG. 10B is a schematic illustration of a back view of the heat sinks of FIG. 10A;

FIG. 11 is a schematic illustration of the induction cooking device of FIG. 5 having another example heat sink for cooling control/power electronics;

FIGS. 12-14 illustrate example additional shapes of an induction cooking device;

FIGS. 15-16 illustrate example induction cooking devices having centrifugal fans;

FIGS. 17-18 illustrate example induction cooking devices having one or more radial fans;

FIG. 19A illustrates a top schematic view of an example built-in induction cooking device;

FIG. 19B illustrates a top schematic view of an inside portion of the built-in induction cooking device of FIG. 19A;

FIG. 20A illustrates a top schematic view of another example built-in induction cooking device; and

FIG. 20B illustrates a top schematic view of an inside portion of the built-in induction cooking device of FIG. 20A.

### DESCRIPTION

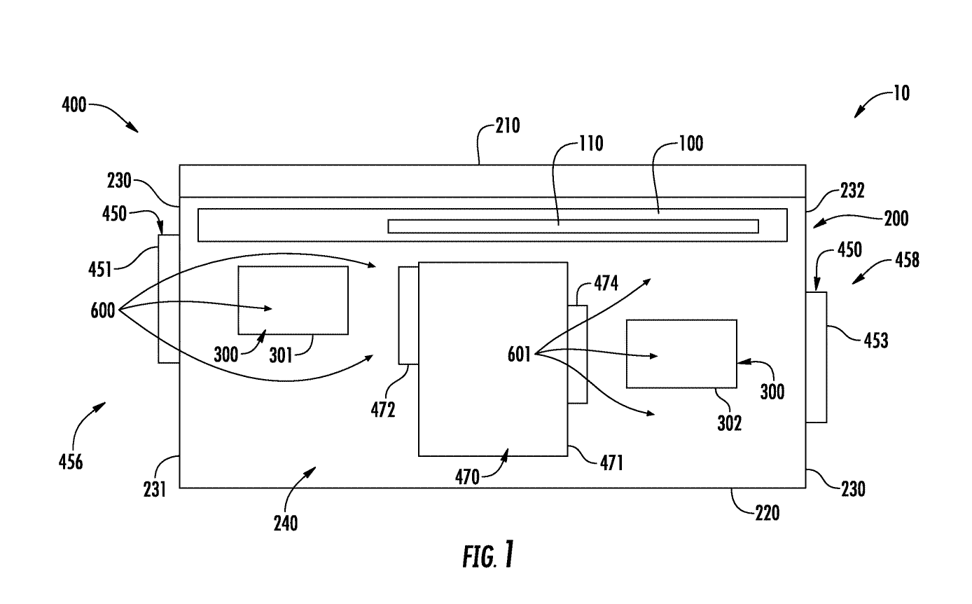

The present disclosure describes various embodiments of induction cooking devices equipped with cooling systems. The present disclosure also describes various embodiments of cooling systems for induction cooking devices, as well as methods of cooling induction cooking devices. Embodiments of the present disclosure may be best understood in reference to the illustrated embodiments provided in FIGS. 1-20B of the drawings, wherein like numerals are used for like and corresponding parts of the various drawings.

The cooling system of an induction cooking device may include one or more fans to draw air into an interior space of the induction cooking device through an intake and move the air through the interior space and out a vent. In some embodiments, the air drawn into the interior space may be used to cool one or more components of the induction cooking device prior to the air entering an input of a fan of the cooling system. In some embodiments, the air exiting an output of the fan may be used to cool one or more components of the induction cooking device prior to the air exiting the interior space of the induction cooking device through the vent. In some embodiments, cooling systems and methods for cooling induction cooking devices may include establishing flows of air within an interior space of an induction cooking device that pass over surfaces of components to be cooled. In a further embodiment, the flows of air may flow along flow paths that preferentially pass over surfaces of components to be cooled. In some embodiments, the vent and intake of the cooking system may be located along a sidewall of the induction cooking device such that the air flows into and out of the interior space horizontally. In some embodiments, any component of an induction cooking device may be cooled using the cooling system. In general, components to be cooled may include a platen surface, an induction coil, control/power electronics, any other components, or any combination thereof.

In some embodiments, the ability to establish a flow path that preferentially passes (e.g., provides a reliable exposure to cooling airflow) over components or surfaces to be cooled provides increased flexibility with respect to induction cooking device design. This may be advantageous, in some embodiments, as induction cooking devices typically have limited available space for cooling and design considerations with respect to the location of the various components within the interior space. An intake and vent configuration providing horizontal flow of air through the interior space (aided by one or more fans) may further reduce space requirements for an induction cooking device, because, in some embodiments, the induction cooking device may be positioned closer to a supporting surface. Also, in some examples it may allow the induction cooking device to have a smaller safety clearance between the supporting surface and the bottom of the induction cooking device, which may lower the profile of the induction cooking device. An intake and vent located at sidewalls may further increase the availability of less restricted airflow. In some embodiments, an intake and vent may be positioned at opposing sides of an induction cooking device, thereby separating available cool air from the heated air exhausted from the interior space of the induction cooking device. In various embodiments, the induction cooking device may have a cylindrical body, which may further reduce space requirements.

FIG. 1 schematically illustrates a side view of an example induction cooking device 10 having a cooling system 400 according to various embodiments. The induction cooking device 10 is configured to heat a cooking vessel (such as a cooking pot, for example) by magnetic induction, instead of by thermal conduction from a flame or an electrical heating element. Additional details regarding induction cooking and/or traditional methods of cooling traditional induction cooking devices) may be found in the following documents, each of which is incorporated herein by reference: U.S. Pat. No. 8,003,924 entitled “Cooking Appliance”; U.S. Pat. No. 8,803,048 entitled “Induction Heating and Control System and Method with High Reliability and Advanced Performance Features”; and U.S. Pat. No. 8,884,197 entitled “Induction Cook Top with Heat Management System”.

As illustrated, the induction cooking device 10 includes an induction assembly 100 mounted to a housing 200. The induction assembly 100 includes an induction coil 110 that may induce a magnetic flux in response to receiving an alternating electric current, for example. This magnetic flux may repeatedly magnetize the cooking vessel, producing eddy currents which cause resistive heating of the cooking vessel, for example.

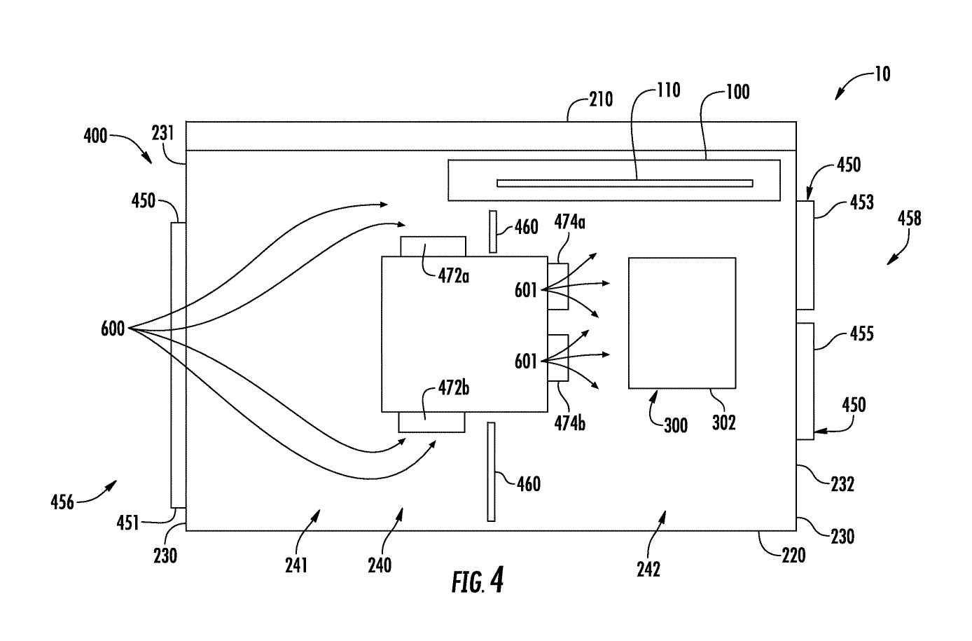

The housing 200 may operate as an external housing to protect the internal components of the induction cooking device 10, and to further prevent a user from contacting the internal components. As such, the housing 200 may operate as a protective grate. The housing 200 of the induction cooking device 10 includes an upper assembly 210, and the upper assembly 210 includes a platen surface 211, examples of which are illustrated in FIGS. 5-8. The platen surface 211 may support the cooking vessel while the cooking vessel is being heated by the induction cooking device 10. In some examples, the platen surface 211 may include a thermal insulating pad, which may reduce the need to cool the platen surface 211. The housing 200 also has a lower wall 220 and a sidewall 230 defining an interior space 240. The interior space 240 of the housing 200 may include control/power electronics 300 (e.g., a circuit board) for modulating operations or power to the induction coil 110. For example, the control/power electronics 300 may provide the electric current to the induction coil 110, or cause the electric current to be provided to the induction coil 110. Examples of these components are further discussed below with regard to FIGS. 5-8.

In some embodiments, it may be advantageous to cool one or more components of the induction cooling device 10. For example, it may be advantageous to cool the induction coil 110, the upper assembly 210 including the platen surface 211, the control/power electronics 300, any other component(s) of the induction cooking device 10, or any combination thereof. To provide such cooling, the induction cooking device 10 includes a cooling system 400 configured to flow a stream of air (or airflows generally depicted by arrows 600 and 601) through the interior space 240 between an intake 456 and a vent 458.

The intake 456 comprises one or more openings 450. In particular, the intake 456 comprises one or more openings 451 that extend through a first portion 231 of the sidewall 230 between an environment exterior to the housing 200 and the interior space 240. Similar to the intake 456, the vent 458 also comprises one or more of the openings 450. In particular, the vent 458 comprises one or more openings 453 that extend through a second portion 232 of the sidewall 230 between the environment exterior to the housing 200 and the interior space 240. In some embodiments, the one or more openings 451 of the intake 456 are spaced apart from the one or more openings 453 of the vent 458.

The cooling system 400 further includes one or more fans 470 positioned within the interior space 240 of an induction cooking device 10. The fans 470 may have an inlet 472 through which airflow is drawn into the fan 470 and an outlet 474 through which airflow discharges from the fan 470. The fans 470 may typically include rotating blades, which may be vanes, impellers, ribs, or other suitable structure(s) known in the art. The blades may be positioned on or extend from a rotatable structure such as a rotor or wheel. Any suitable blade type may be used. For example, depending on the configuration, the fan 470 may include radial blades or blades that are curved forward or backward. In various embodiments, the fans 470 may be one or more of an axial fan, a cross-flow fan, a centrifugal fan, a radial fan, a multi-stage fan, or any combination thereof. In a centrifugal fan, for example, rotation of an impeller (or blades) increases the velocity of air drawn into the inlet 472, which is then converted to pressure within the housing. The air in the housing of the fan 470 then discharges from the outlet 474 having flow characteristics such as rate, velocity, and pressure. In various embodiment, the fan 470 may be a blower. In some embodiments, the fans 470 may include ducts configured to modify the location, size, orientation, or any other parameter, of inlet 472 or outlet 474. In various embodiments, one or more thermocouples may be used to monitor temperatures and initiate operation of one or more of the fans 470.

As illustrated, the fans 470 include one or more housings 471 to which rotatable blades (see, e.g., FIG. 8) are mounted. In operation, the one or more fans 470 create a low pressure environment at and/or adjacent to an inlet 472 and a higher pressure environment at and/or adjacent to an outlet 474. As such, the one or more fans 470 draw external airflow 600 into the intake 456 and along a flow path that extends through the interior space 240 between the intake 456 and the inlet 472 of the fan 470. After exiting the fan 470 through the outlet 474, the airflow 601 flows back into the interior space 240 adjacent to the outlet 474 where it may flow along a flow path, toward, and out the vent 458 separating the interior space 240 from the lower pressure exterior environment.

In various embodiments, the components or component surfaces to be cooled may be located between the intake 456 and inlet 472, between the outlet 474 and vent 458, or both. For example, the control/power electronics 300 may be positioned between the intake 456 and the inlet 472 (as indicated by 301 in FIG. 1), between the outlet 474 and the vent 458 (as indicated by 302 in FIG. 1), or both, as illustrated in FIG. 1. However, it is to be appreciated that the control/power electronics 300 may be positioned in any other location in the internal space 240 of the induction cooking device 10.

According to various embodiments, the components or component surfaces to be cooled may be located in or along (e.g., adjacent to) a flow path of airflows 600, 601 moving through the interior space 240. For example, the control/power electronics 300 may be positioned along a flow path of airflow 600 between the intake 456 and inlet 472, along a flow path of airflow 601 between the outlet 474 and vent 458, or both. In this or another example, the induction coil 110 may be positioned along a flow path of airflow 600 between the intake 456 and inlet 472, along a flow path of airflow 601 between the outlet 474 and vent 458, or both. In either of the above examples or another example, the platen surface 211 may be positioned along a flow path of airflow 600 between the intake 456 and inlet 472, along a flow path of airflow 601 between the outlet 474 and vent 458, or both.

The intake 456 of the induction cooking device 10 may be located along the first portion 231 of the sidewall 230 relative to the inlet 472 such that external airflow 600 is drawn into the interior space 240 and flows along a flow path adjacent to the component or component surface(s) (e.g., 110, 210, 300) of the induction cooking device 10. One or more flow paths between the inlet 472 and outlet 474, such as direct flow paths or one or more routed paths, may form a preferred path for airflows 600, 601 wherein flow characteristics such as flow rate or flow volume may be greater than areas adjacent to the flow path. For example, one or more components to be cooled may be positioned along a preferred flow path along which airflows 600, 601 preferentially flow between the intake 456 and inlet 472 or the outlet 474 and vent 458.

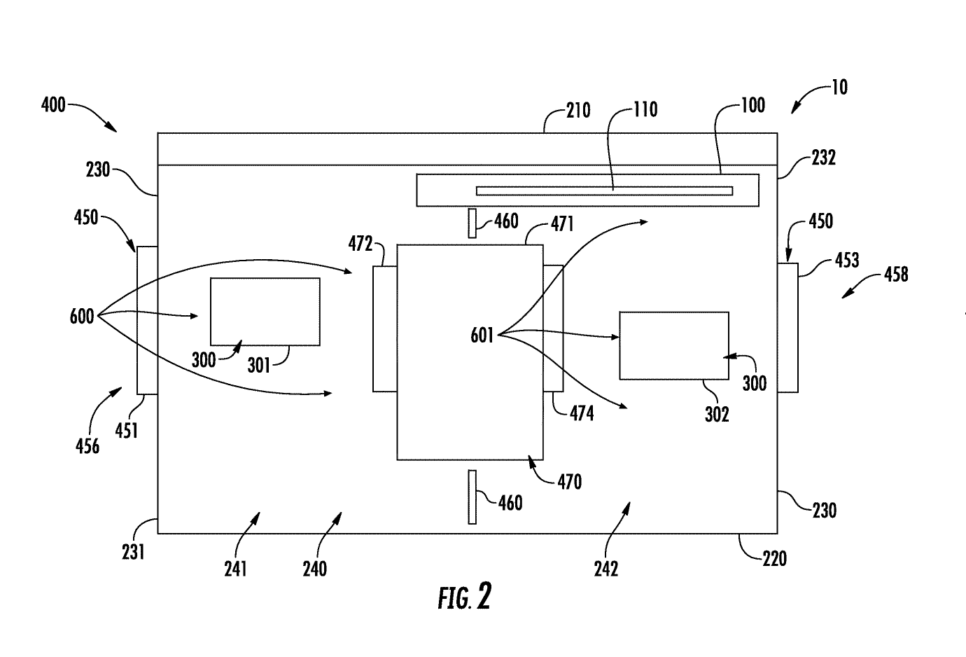

In various embodiments and with reference to FIGS. 2-8, the cooling system 400 may include one or more baffles 460 to assist in the flow of air through the interior space 240. A baffle 460 may be any structure or member that blocks air flow in one location, so that the air flow can be directed to another region. The baffles 460 may control the airflows 600, 601 between the intake 456 and inlet 472, between the outlet 474 and the vent 458, or any combination thereof. For example, the baffles 460 may be used to modify the flow paths such that the preferred path of airflows 600, 601 is routed around, along, or toward a component to be cooled, such as the platen surface 211, the induction coil 110, the control/power electronics 300, any other component, or any combination thereof. The baffles 460 may further divide or compartmentalize the interior space 240 of the housing 200 to, for example, assist in establishing or maintaining a pressure differential driven by the fan(s) 470. This pressure differential draws air into the interior space 240 at the intake 456 and expels the air at the vent 458 after the air has been flowed through the interior space 240. In some embodiments, the baffles 460 may also be used to create turbulence along a portion of a flow path. In some embodiments, the baffles 460 may be formed by components to be cooled or comprise other structures, such as walls or barriers, configured to regulate or restrain airflow.

The baffles 460 may be positioned within the interior space 240 to separate the interior space 240 into portions (which may be referred to as compartments herein). An inlet 472 and outlet 474 of the one or more fans 470 may be separated by baffles 460, where the inlet 472 may be positioned within a first compartment 241 and the outlet 474 may be positioned within a second compartment 242 that is adjacent to the first compartment 241. This may cause airflows 600 to be drawn into the inlet 472 from the first compartment 241, and may further cause airflows 601 to be discharged from the outlet 474 into the second compartment 242 by operation of the one or more fans 470. In one embodiment, the cooling system 400 and method of cooling induction cooking devices 10 may include locating one or more fans 470 within an interior space 240 of the induction cooking device 10, wherein operation of the fan 470 draws airflow 600 into the first compartment 241 of the interior space 240 to cool components therein prior to the air reaching an inlet 472 of a fan 470. The cooling system 400 and method of cooling an induction cooking device 10 may further include discharging the airflow 601 from the outlet 474 into the second compartment 242 of the interior space 240 (separated from the first compartment 241 by one or more baffles 460) to further cool components therein prior to the airflow 601 exiting the interior space 240 at the vent 458. In some examples, positioning the fans 470 in the first compartment 241 only, and further positioning electrical components (such as the control/power electronics 300) in the second compartment 242 only, may allow for more efficient placement/cooling of the components, as the components which produce the most heat may be positioned immediately adjacent to the outlets of the fans.

In various embodiments, the baffles 460 may be positioned within the interior space 240 at a location that restricts airflow 600/601 within the interior space 240 between the intake 456 and vent 458. For example, as is illustrated in FIG. 2, the baffles 460 are positioned within the interior space 240 at a location that restricts airflow 600/601 within the interior space 240 around the fan 470 between the inlet 472 and outlet 474 of the fan 470. The interior space 240 includes a first compartment 241 and a second compartment 242 separated by the baffles 460. The first compartment 241 is in fluid communication with the exterior environment through the intake 456 along the first portion 231 of the sidewall 230, and is further in fluid communication with the second compartment 242 through the fan 470. The second compartment 242 is in fluid communication with the first compartment 241 through the fan 470, and is further in fluid communication with the external environment through the vent 458 along the second portion 232 of the sidewall 230. The baffles 460 are positioned to restrict airflow between the first compartment 241 and the second compartment 242 within the interior space 240, other than through the fan 470. Thus, two adjacent compartments 241, 242 may be in fluid communication through an inlet 472 and outlet 474 of the fan 470 situated between the compartments 241, 242, but airflows 600, 601 may be otherwise completely or partially restricted between the compartments 241, 242 within the interior space 240 along the baffles 460. It will be appreciated that when the fan 470 is in operation, fluid communication may be essentially one way fluid communication from the inlet 472 to the outlet 474 with respect to the direction of airflow. In at least one embodiment, the fan 470 is a reversible fan 470, wherein reversing the fan 470 may reverse the direction of airflow through the interior space 240. In various embodiments, the airflow 601 is discharged in a broad pattern from the outlets 474 to provide a wide area of flow coverage that includes the upper assembly 210 (including the platen surface 211), the induction coil 110, the control/power electronics 300, any other components, or any combination thereof The housing 200 may form boundaries causing turbulence that increases flow volume and encourages air movement within the second compartment 242 before the airflow 601 exits the vent 458.

As is introduced above, the intake 456 of the induction cooking device 10 comprises one or more openings 450 (such as openings 451), and the vent 458 of the induction cooking device 10 also comprises one or more openings 450 (such as openings 453). The openings 450 of the intake 456 and/or the vent 458 may include any number of openings. For example, the openings 450 of the intake 456 and/or the vent 458 may each be a single opening. As another example, the openings 450 of the intake 456 and/or the vent 458 may each be multiple openings (e.g., a set of openings 451 or a set of openings 453). In embodiments where the openings 450 of the intake 456 and/or the vent 458 are multiple openings, the openings 450 may be two or more spaced apart openings or two or more spaced apart sets of openings. The openings 450 may be spaced apart from an adjacent opening 450 by any amount of distance, and may further be spaced apart in any direction, such as spaced apart vertically and/or horizontally. The openings 450 (or set of openings) may further have any size, shape, location, and/or orientation. In some examples, concave slats (or other portions of the sidewall 230) may extend between adjacent openings 450 (or adjacent sets of openings 450).

According to various embodiments, one or more of the location, orientation, size, shape, or number of openings 450 may be configured to provide one or more desired flow characteristics, such as a path, volume, rate, or any combination thereof. In various embodiments, the location of openings 450 may be configured to provide one or more desired flow characteristics. As a first example, as is illustrated in FIGS. 1 and 2, the one or more openings 451 (or set of openings) forming the intake 456 are positioned in a location on the sidewall 230. This results in air being drawn into induction cooking device 10 in a generally horizontal direction, as is seen in FIGS. 1 and 2. A generally horizontal direction refers to a direction that has a larger horizontal component than a vertical component. In these examples, the inlet 472 is positioned on a sidewall of the fan 470, causing the airflow to be drawn into the fan 470 in a generally horizontal direction, also. Additionally, the one or more openings 453 (or set of openings) forming the vent 458 are positioned on the sidewall 230, causing the airflow to be discharged from the induction cooking device 10 in a generally horizontal direction. In these examples, the outlet 472 is positioned on another sidewall of the fan 470, causing the airflow to be discharged from the fan 470 in a generally horizontal direction, also. As such, the airflow through the induction cooking device 10 may all be in a generally horizontal direction (or generally horizontal directions).

Alternatively, as a second example, the intake 456 and/or vent 458 may be positioned in the lower wall 220, causing the air drawn into the induction cooking device 10 and/or discharged from the induction cooking device 10 to be drawn/discharged in a generally vertical direction. A generally vertical direction refers to a direction that has a larger vertical component than a horizontal component.

As a third example, the openings 451, 453 (or set of openings) of the intake 456 or vent 458 may be located along respective sidewall portions 231, 232 relative to a corresponding inlet 472 and outlet 474 of the fan 470 such that airflow 600, 601 drawn into the first compartment 241 at the intake 456 or into the second compartment 242 at the outlet 474 preferentially passes along a surface of one or more of the components to be cooled. The location chosen for the openings 451, 453 (or set of openings) may be higher, lower, or substantially equivalent in elevation and/or lateral distance relative to the corresponding inlet 472 or outlet 474. Thus, an intake 456 that is offset from an inlet 472 or an outlet 474 that is offset from a vent 458 may provide flow paths that include vertical or horizontal components or both.

According to various embodiments, the orientation of openings 450 may also be configured to provide one or more desired flow characteristics. The openings 450 of the intake 456 and the vent 458 may have any orientation, such as horizontal, vertical, or any angle in-between. In some examples, the orientation of openings 450 may create a crossing or merging flow pattern of airflows 600, 601. This crossing or merging flow pattern may be used, for example, to expose multiple surfaces of the same or different components to cooling airflows 600, 601.

According to various embodiments, the shape or cross-section of openings 450 may also be dimensioned to provide one or more desired flow characteristics. As a first example, one or more of the openings 450 may include cross-sectional areas configured to provide increased flow volume and/or flow rate along a surface of a component to be cooled. The openings 450 may be wide or elongated openings (or sets of openings) that are shaped to provide wider flow paths or lower velocity flows than narrower or focused openings (or set of openings). Openings 450 (or sets of openings) may also be shaped to provide turbulence within airflows 600, 601 moving along a flow path.

As a second example, opening 451 (or set of openings) of the intake 456 may extend along a length of the first portion 231 of the sidewall 230 such that when airflow 600 is drawn into the first compartment 241, the airflow 600 moves along a corresponding length within the first compartment 241 toward the inlet 472. The size of the opening 451 (or set of openings) may include a smaller, same, or a larger length (in comparison to the inlet 472) to modify the flow path of the airflow 600. For example, the length of the opening 451 (or set of openings) may be larger than the length of the inlet 472, causing the airflow 600 to move along a flow path that narrows (or focuses) as the airflow 600 moves toward the inlet 472. As another example, the length of the opening 451 (or set of openings) may be smaller than the length of the inlet 472, causing the airflow 600 to move along a flow path that expands as the airflow 600 moves toward the inlet 472. In this or another embodiment, opening 453 (or set of openings) may extend along a length of the second portion 232 of the sidewall 230 such that when airflow 601 is moved into the second compartment 242, the airflow 601 moves toward the vent 458 to obtain a width of flow at the vent 458. For example, the length of the outlet 474 may be smaller than the length of the vent 458, so that the airflow 601 moves along a flow path that expands. As another example, the length of the outlet 474 may be greater than the length of the vent 458, so that the airflow 601 moves along a flow path that narrows. As such, the outlet 474 may provide a focused or broad discharge with respect to the vertical or horizontal length of the airflow 601.

According to various embodiments, the number of openings 450 may be configured to provide one or more desired flow characteristics. As a first example, the intake 456 may include multiple openings 451 (or multiple sets of openings) that are spaced apart from each other to provide multiple flow paths along which airflow 600 drawn into the first compartment 241 may flow toward an inlet 472. Similarly, the vent 458 may include multiple openings 453 (or multiple sets of openings) that are spaced apart to provide multiple flow paths along which airflow 601 exiting the fan 470 at the outlet 474 may flow toward the vent 458. Thus, the intake 456 or vent 458 may include multiple openings 451, 453 spaced apart along the first portion 231 of the sidewall 230 or the second portion 232 of the sidewall 230 to provide desired flow paths, rates, volumes, or any combination thereof, passing along surfaces of components to be cooled. In one embodiment, the two or more spaced apart openings 451, 453 (or sets of openings) of an intake 456 and/or vent 458 may be positioned to create a crossing or merging flow pattern within the first compartment 241 or second compartment 242. For example, two spaced apart openings 451 (or sets of openings) of the intake 456 may form two flow paths that merge into a single inlet 472.

In an embodiment wherein the intake 456 comprises two or more spaced apart openings 451 (or sets of openings), the cross-sectional area of a first opening 451 (or combined cross-sectional area of a set of first openings) may be larger than a cross-sectional area of a second opening 451 (or combined cross-sectional area of a set of second openings) that is spaced apart from the first opening 451 along the first portion 231 of the sidewall 230. Thus, more airflow 600 may flow along the flow path between the first opening 451 (or set of first openings) and the inlet 472 than along the flow path between the second opening 451 (or set of second openings) and the inlet 472.

Similar to the openings 450, one or more of the location, orientation, size, shape, or number of inlets 472 or outlets 474 of the fan(s) 470 may also (or alternatively) be configured to provide one or more desired flow characteristics, such as a path, volume, rate, or any combination thereof. In various embodiments, the location of inlets 472 or outlets 474 may be configured to provide one or more desired flow characteristics.

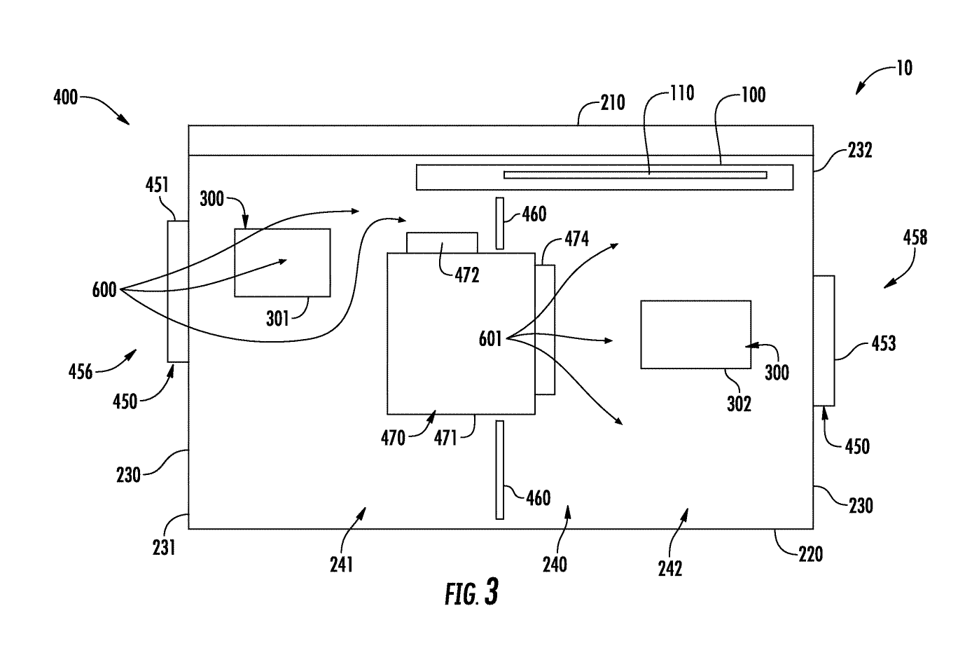

As a first example, as is illustrated in FIGS. 3 and 4, the one or more inlets 472 of the fan(s) 470 are positioned in a location on the top and/or bottom wall of the fan 470 (as opposed to the sidewall). This results in air being drawn into the fan 470 in a generally vertical direction. In these examples, the intake 456 is positioned on the sidewall 230, causing the airflow to be drawn into the induction cooking device 10 in a generally horizontal direction, but further causing the airflow to change to a generally vertical direction when (or before) being drawn into the fan 470. In other examples, the intake 456 is positioned in the lower wall 220, causing the airflow to be drawn into both the induction cooking device 10 and the fan 470 in generally vertical directions. Additionally, the one or more outlets 474 of the fan 470 are positioned in a location on the sidewall of the fan 470, causing the airflow to be discharged from the fan 470 in a generally horizontal direction. Alternatively, the one or more outlets 474 of the fan 470 may be positioned in a location on the top and/or bottom wall of the fan 470, causing the airflow to be discharged from the fan 470 in a generally vertical direction

As a second example, an inlet 472 or outlet 474 may be located along a fan housing 471 (such as the sidewall or top/bottom wall of the fan housing 471) at an elevation relative to a corresponding intake 456 or vent 458 such that airflows 600, 601 drawn into the first compartment 241 at the intake 456 or moved into the second compartment 242 at the outlet 474 preferentially passes along a surface of a component to be cooled. The location chosen for the inlet 472 or outlet 474 may be higher, lower, or substantially equivalent in elevation relative to an opening 451, 453 (or set of openings) that form the corresponding intake 456 or vent 458. In embodiments including multiple inlets 472 (see, e.g., FIG. 4), the inlets 472 may be horizontally or vertically spaced apart.

In various embodiments, the orientation of an inlet 472 or outlet 474 relative to an orientation of one or more openings 450 of an intake 456 or vent 458 may be used to provide desired flow characteristics. For example, vertically or horizontally oriented inlets 472 or outlets 474 may be used to modify airflows 600, 601. In some embodiments, one or more inlets 472 or outlets 474 are oriented at an angle between the horizontal and vertical.

According to various embodiments, the shape or cross-section of an inlet 472 or an outlet 474 may also be dimensioned to provide one or more desired flow characteristics. For example, the inlet 472 or the outlet 474 may include cross-sectional areas and/or shapes dimensioned to provide increased/decreased flow volume, rate, turbulence, or any combination thereof along one or more surfaces of a component to be cooled. A decreased cross-sectional dimension of an inlet 472 or outlet 474 may increase focus of an airflow 600, 601 between the inlet 472 or outlet 474 and the respective intake 456 or vent 458. This more focused flow path may provide, for example, an increased flow rate or volume of airflow 600, 601 over a desired component surface to be cooled along the flow path. On the other hand, an increased cross-sectional dimension (such as width or height) of an inlet 472 or outlet 474 may provide a wider or taller flow path. This wider or taller flow path may increase the area in which airflows 600, 601 preferentially flow, thereby potentially increasing the surface area of the component that may be exposed to cooling airflows 600, 601, but also potentially decreasing the flow rate or volume of air passing along a particular surface area.

As another example, the inlet 472 may extend along a vertical or horizontal length of the first compartment 241, such that when airflow 600 is drawn into the first compartment 241 through the intake 456, the airflow 600 moves along a flow path having a corresponding length within the interior space 240 toward the inlet 472. In various embodiments, the size of the inlet 472 may include a smaller, same, or larger length than the intake 456. For example, an inlet 472 having a smaller length than the length of the intake 456 may tend to increase focus of an airflow 600 as it flows toward the inlet 472 from the larger intake 456. As another example, an inlet 472 having a larger length than the length of the intake 456 may tend to broaden an airflow 600 as it flows toward the inlet 472.

In various embodiments, the number of inlets 472 or outlets 474 may also be configured to provide one or more desired flow characteristics. As a first example, in one embodiment, the cooling system 400 includes multiple inlets 472, which may be spaced apart to provide multiple flow paths within the first compartment 241. A first inlet 472 may include a greater cross-sectional area than a second inlet 472 to provide a greater flow volume to a component surface along a flow path between the intake 456 and the larger inlet 472. Similarly, the outlet 474 may include multiple outlets 474, which may be spaced apart to provide multiple flow paths along which airflow 601 exiting the fan 470 may flow toward the vent 458.

As a second example, an inlet 472 may include two spaced apart inlets 472a, 472b positioned to create a crossing or merging flow pattern within the first compartment 241. The two spaced apart inlets 472a, 472b may be used to establish separate flow paths from an intake 456, which may include a single opening 451, two or more spaced apart openings 451, or two or more spaced apart sets of openings 451.

FIG. 3 schematically illustrates a side view of another example induction cooking device 10 having a cooling system 400 according to various embodiments. As illustrated, the fan 470 of the cooling system 400 includes an inlet 472 positioned on a top wall of the fan 470. Airflow 600 may be drawn into the first compartment 241 of the interior space 240 through the opening 451 (or set of openings), and the airflow 600 may preferentially flow along a flow path that passes along a surface of a component to be cooled (e.g., the platen surface 211 of the upper assembly 210, the control/power electronics 300/301, or both). It will be appreciated that in some embodiments, the induction coil 110 may be within or partially within the first compartment 241 and the cooling system 400 may be configured to provide cooling airflows 600 to the induction coil 110. It will also be appreciated that the platen surface 211, control/power electronics 300, or both, may be partially or entirely within the second compartment 242, and thus the cooling system 400 may not provide cooling airflows 600 to such components within the first compartment 241.

The opening 451 (or set of openings) of intake 456 is positioned in the sidewall 230. The inlet 472 is positioned at an elevation that is approximately equal to the top-most vertical position of the opening 451 (or set of openings). The location of the inlet 472 is further located approximate to the upper assembly 210 and control/power electronics 300/301. When airflows 600 flow between the intake 456 and the inlet 472, the flow path moves along the surface of the platen surface 211 of the upper assembly 201 to provide the cooling airflow 600 there along. The outlet 474 and opening 453 (or set of openings) of the vent 458 are positioned on the sidewall of the fan 470 and sidewall 230, respectively, and positioned at similar elevations. The airflow 601 is discharged in a broad pattern from the outlet 474 to provide a wide area of flow coverage that includes the upper assembly 210, the induction coil 110, and the control/power electronics 300. The housing 200 may form boundaries causing turbulence that increases flow volume and encourages air movement within the second compartment 242 before the airflow 601 exits the vent 458.

FIG. 4 schematically illustrates a side view of another example induction cooking device 10 having a cooling system 400 according to various embodiments. As is illustrated, the one or more fans 470 of the cooling system 400 include an upper inlet 472a positioned on a top wall of the fan 470 and a lower inlet 472b positioned on a bottom wall of the fan 470. The fans 470 also include two spaced apart outlets 474a, 474b positioned on the sidewall of the fans 470. The vent 458 includes two spaced apart openings 453, 455 (or sets of openings). The opening 451 (or set of openings) of the intake 456 has a vertical length that extends vertically upward to a location that is approximately equivalent (or higher) in elevation to the top-most location of the upper inlet 472a, and that further extends vertically downward to a location that is lower in elevation than the bottom-most location of the lower inlet 472b. Airflow 600 entering the first compartment 241 of the interior space 240 through the intake 456 moves along a dividing flow path toward one of the inlets 472a, 472b. The division of the airflow 600 imparts a vertical component to the flow path.

The airflow 600 that moves toward inlet 472a may be drawn or routed along the upper assembly 210, prior to being drawn into the fan 470 in a generally vertical direction. In one embodiment, this portion of the airflow 600 may be used to cool the platen surface 211 of the upper assembly 210. In another embodiment, however, the platen surface 211 is disposed elsewhere, such as in (or above) the second compartment 242. It will be appreciated that in some embodiments, the induction coil 110 may be within or partially within the first compartment 241 and the cooling system 400 may be configured to provide cooling airflows 600 to the induction coil 110. It will also be appreciated that the platen surface 211, control/power electronics 300, or both, may be partially or entirely within the second compartment 242 and thus the cooling system 400 may not provide cooling airflows 600 to such components within the first compartment 241.

Airflow 601 exiting the one or more fans 470 is discharged from the outlets 474a, 474b, which are spaced apart either horizontally, vertically, or components of both. The airflow 601 is discharged in a broad pattern from both outlets 474a, 474b to provide a wide area of flow coverage that includes the upper assembly 210, the induction coil 110, and the control/power electronics 300. The housing 200 may form boundaries causing turbulence that increases flow volume and encourages air movement within the second compartment 242 before the airflow 601 exits the vent 458. The broad pattern of the airflow 601 may also include an overlap region into which both airflows 601 are discharged.

Those having skill in the art will appreciate upon reading the present disclosure that the features described above with respect to FIGS. 1-4 may be used alone or in any combination to achieve desired flow characteristics, such as flow path, volume, rate, or any combination thereof.

It will be further appreciated that the induction cooking device 10 may include a cooling system 400 with an interior space 240 that includes multiple first compartments 241 divided by baffles 460. The first compartments 241 may be in fluid communication with one or more inlets 472 of one or more fans 470. Each first compartment 241 may include one or more openings 451 (or sets of openings) forming an intake 456 into the interior space 240. Each first compartment 241 may supply air to a separate inlet 472, which may be an inlet 472 to the same or a different fan 470. In some embodiments, the induction cooking device 10 may include a cooling system 400 having multiple fans 470 positioned within the interior space 240. Multiple fans 470 may be provided between a single first compartment 241 and a single second compartment 242 of the interior space 240. In one such embodiment or a different embodiment, a first single fan 470 may be provided between one first compartment 241 and one second compartment 242, and one or more additional fans 470 may be provided between another first compartment 241 and one or more second compartments 242 of the interior space 240, which may or may not be the second compartment 242 in which the first single fan 470 is provided between. In one embodiment, a single fan 470 may be provided between one first compartment 241 and one or more second compartments 242. In another embodiment, a single fan 470 may be provided between multiple first compartments 241 and a single second compartment 242 of the interior space 240.

FIGS. 5-11 illustrate various views of an example induction cooking device 10 having a cooling system 400 according to various embodiments. The induction cooking device 10 of FIGS. 5-11 may have any of the cooling systems 400 described above with regard to FIGS. 1-4, or any other cooling system 400.

The induction cooking device 10 may be any type of induction cooking device. As is illustrated, the induction cooking device 10 is a portable cooking device. A portable (or counter top) induction cooking device refers to a cooking device that is easily transportable and moveable for table or countertop use. Such portable induction cooking devices generally weigh less than about 15 to 25 lbs. (33-55 Kg.), and do not exceed more than about 2-3 ft. (60-90 cm) in any one dimension, but usually do not greatly exceed more than about 18-22 inches (46 cm-56 cm) in width in one dimension so as to fit on top of tables and conventional 24 inch deep (60 cm) kitchen counter tops. Additionally, such portable induction cooking devices are generally thin and compact devices that are not much larger than the platen that supports the cooking vessel. In some examples, the portable induction cooking device 10 may have one or more of these above referenced dimensions. In some examples, the portable induction cooking device 10 may weigh less than 10 lbs. (such as less than 5 lbs.), have a diameter that does not exceed 16 inches (such as a 12.5 inch diameter), have a total height (including the legs discussed below) that does not exceed 5 inches (such as 4 inches, and more preferably less than 3 inches, such as 2 inches). Having a size and weight within the above parameters generally allows the portable cooking device to be safely lifted and transported by a single adult sized person.

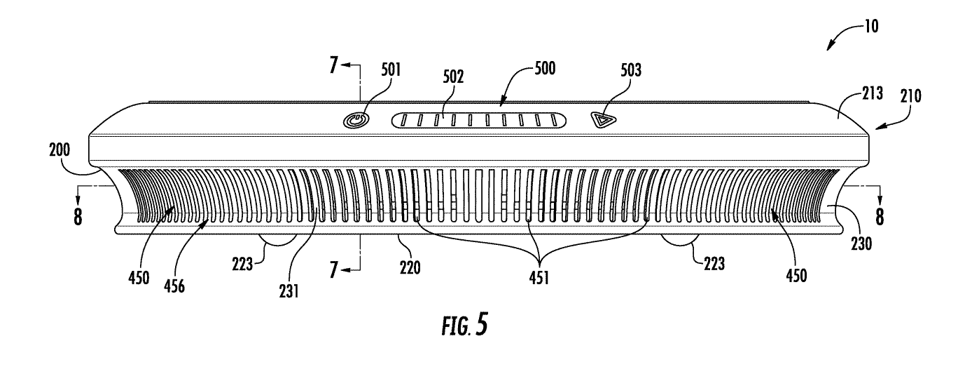

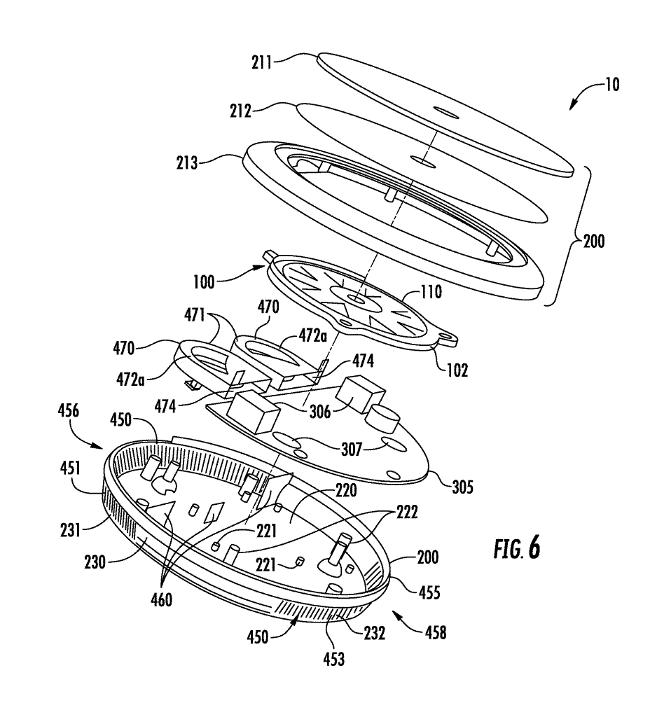

Referring to the elevated front view shown in FIG. 5 and the exploded view shown in FIG. 6, the induction cooking device 10 includes an induction assembly 100 mounted to a cylindrical housing 200. The induction assembly 100 includes an induction coil 110 and a support 102, as is illustrated in FIG. 6. The housing 200 includes an upper assembly 210, a lower wall 220, and a sidewall 230 defining an interior space 240. The sidewall 230 also defines a concave outer periphery configured to receive a power cable for providing power to the induction cooking device 10. For example, a power cable may be wrapped around the concaved surface about the periphery of the housing 200. In some examples, the power cable may include a power cord and plug generally configured for residential line voltage sockets (e.g., 120 volts of alternating current (VAC) in the U.S., 220 VAC in Europe and other counties, and 100 VAC in Japan).

Although the induction cooking device 10 is illustrated as only having a single induction assembly 100/induction coil 110, the induction cooking device 10 may have more than one induction assembly 100/induction coil 110, and the induction assembly 100s/induction coil 110s may be positioned adjacent to each other. In some examples, this may allow the induction cooking device 10 to heat more than one cooking vessel at the same time (e.g., with each cooking vessel being heated by its own induction coil 110). When the induction cooking device 10 is a portable cooking device, it generally does not include more than 2 adjacent induction assembly 100s/induction coil 110s, each associated with an overlaying platen intended to support and heat a cooking vessel.

The upper assembly 210 includes a generally circular platen surface 211, insulation pad 212, and bezel 213, as is illustrated in FIG. 6. The platen surface 211 may be sized to fit any type of cooking vessel. As an example, the platen surface 211 may be sized to fit a cooking vessel having a diameter of about 6 to 14 inches (15-36 cm). A user interface 500 is located along the bezel 213 so as be front facing for easy access and viewing by a user. In other examples, the user interface 500 may be located on the side or top of the device, adjacent the platen 211. The user interface 500 includes a power button 501 for initiating delivery of power to the induction cooking device 10. The user interface 500 also includes a display touch sensor 502 and an advance button 503. The display touch sensor 502 and the advance button 503 may be operative with one or more of the features (such as the features of an electronic cookbook) described in U.S. Patent Application Publication No. 2016/0051078 entitled “Automated Cooking Control Via Enhanced Cooking Equipment,” published Feb. 25, 2016; U.S. patent application Ser. No. 15/434,695 entitled “Wirelessly Controlled Cooking System;” U.S. patent application Ser. No. 15/436,166 entitled “Auxiliary Button for a Cooking System;” and U.S. patent application Ser. No. 15/435,879 entitled “User Interface for a Cooking System;” each of which is incorporated herein by reference in its entirety.

Although the induction cooking device 10 is illustrated as including a particular user interface 500, the induction cooking device 10 may include any other type of user interface that may allow a user to control the induction cooking device 10, control the power/temperature of the induction cooking device 10, view the current power/temperature of the induction cooking device 10, view and/or control any other feature of the induction cooking device 10, or any combination of the preceding.

Legs 223 extend from an exterior side of the lower wall 220 and are operable to position the lower wall 220 above a surface upon which the induction cooking device 10 may be placed. The legs 223 are sized to position the intake 456 and vent 458 (discussed below) a safe distance from the countertop or other surface on which the induction cooking device 10 is positioned. Mounts 221 (illustrated in FIG. 6) are provided along an interior surface of the lower wall 220 for mounting the control/power electronics 300 (which includes a printed circuit board 305 and circuit components such as capacitors 306). The circuit board 305 includes holes 307 through which mounting posts 222 may extend from the interior surface of the lower wall 220 to mount the support 102 to the housing 200.

The induction cooking device 10 is equipped with a cooling system 400 that includes an intake 456 and a vent 458, each comprising a plurality of openings 450. The intake 456 includes a plurality of openings 451 positioned along a first portion 231 of the sidewall 230. This first portion 231 is located along a forward portion of the induction cooking device 10 (e.g., the front facing portion of the sidewall 230). The openings 451 are configured to allow air to flow into the induction cooking device 10 in a direction that is generally horizontal. The openings 451 extend along a perimeter of the housing 200. As shown, the openings 451 extend a distance around the perimeter of the housing 200 of approximately 35% to approximately 50% of the sidewall 230, and occupy approximately 50% of that distance. The remaining approximately 50% of the distance is occupied by concave slats (or other portions of the sidewall 230) that extend between the openings 451. In other embodiments, the openings 451 may occupy a greater or lesser distance or portion of the sidewall 230.

In some examples, the size of the intake 456 may correspond to the size of inlet(s) into fans 470. For example, the size of the intake 456 may be at least 30% of the size of the inlet(s) into a fan 470, at least 40% of the size of the inlet(s) into a fan 470, at least 45% of the size of the inlet(s) into a fan 470, at least 50% of the size of the inlet(s) into a fan 470, a range of 30%-50% of the size of the inlet(s) into a fan 470, a range of 30%-45% of the size of the inlet(s) into a fan 470, a range of 35%-50% of the size of the inlet(s) into a fan 470, or a range of 40%-50% of the size of the inlet(s) into a fan 470. In some examples, the size of the intake 456 may be approximately equal to the size of the inlet(s) into a fan 470. The size of the intake 456 may refer to the collective size of only the openings 451 of the intake 456 (not the concave slats or other portions of the sidewall 230 that separate adjacent openings 451 from each other). Additionally, the size of the inlets into the fans 470 may refer to the size of the open area in all of the inlets into a particular fan 470 (less the solid hub of the fan).

The vent 458 of the induction cooking device 10 includes two spaced apart sets of openings 450 that together extend along a perimeter of the housing 200, as is illustrated in FIGS. 6 and 8. For example, the vent 458 includes a first set of a plurality of openings 453 and a second set of a plurality of openings 455 positioned along a second portion 232 of the sidewall 230. This second portion 232 is located along a rear portion of the induction cooking device 10 (e.g., the rear facing portion of the sidewall 230). In some examples, this may result in the vent 458 and intake 456 being positioned on opposing sides of the sidewall 230. The two sets of openings 453, 455 are configured to allow air to flow out of the induction cooking device 10 in a direction that is generally horizontal. As shown, the two sets of openings 453, 455 together extend a distance around the perimeter of the housing 200 of approximately 20% to 35% of the sidewall 230 and occupy approximately 50% of that distance. The remaining approximately 50% of the distance is occupied by concave slats (or other portions of the sidewall 230) that extend between the openings 453, 455. In other embodiments, the openings 453, 455 may occupy a greater or lesser distance or portion of the sidewall 230. In further embodiments, the vent 458 may include a single set of openings 450.

In various embodiments, having an intake 456 and vent 458 positioned along the sidewall 230 may allow improved cooling compared to embodiments where an intake 456 or vent 458 is positioned along the lower wall 220. Furthermore, having an intake 456 and vent 458 positioned along the sidewall 230 may allow for a reduced height of the induction cooking device 10. In some examples, this may allow the induction cooking device 10 (such as a portable or countertop induction cooking device 10) to have a low profile. As an example of low profile, the total height of the induction cooking device 10 above the counter may be less than about 4 inches, and more preferably less than about 3 inches. In some examples, low profile portable appliances are easier and more convenient to use, as they may be more similar to a built-in appliance, in which the cooking vessel support is flush with the adjacent kitchen counter, island, or workspace.

With further reference to FIG. 7 (showing a cross-sectional side view of the induction cooking device of FIG. 5 taken along line 7-7 of FIG. 5) and FIG. 8 (showing a cross-sectional top view of the induction cooking device of FIG. 5 taken along line 8-8 of FIG. 5), the cooling system 400 includes two fans 470 mounted to the housing 200 within the interior space 240. Although two fans 470 are illustrated, fewer or additional fans 470 may be included in the cooling system 400. In some examples, the number of fans 470 included in the cooling system 400 may correspond to the number of burners (e.g., assembly 100/induction coil 110) included in the induction cooking device 10, with each burner being capable of heating a separate cooking vessel. For example, the cooling system 400 may include 3 or more fans 470 for each burner, 2 fans 470 for each burner, 1 fan 470 for each burner, 1 fan 470 for 2 burners, 1 fan 470 for 3 burners, or 1 fan for 4 or more burners.

Each fan 470 includes a housing 471, two inlets 472a, 472b, and an outlet 474. The fans 470 may be centrifugal fans having inlets 472a, 472b that draw air into the fan in a generally vertical direction, and outlets 474 to expel air out of the fan in a generally horizontal direction. The fans 470 include vertically oriented blades 475 positioned around and spaced apart from a rotation axis (only one set of blades 475 is shown in FIG. 8). The blades 475 may be radial, forward curved, or backward curved. As shown, the blades 475 are curved forward. Baffles 460 are positioned in the housing 200 to separate the interior space 240 into a first compartment 241 and a second compartment 242, as is illustrated in FIG. 8. The cooling system 400 is configured to draw external airflow 600a, 600b into the first compartment 241 of the interior space 240, where the airflows 600a, 600b flow along a flow path toward the inlets 472a, 472b. In operation, airflows 600a, 600b are drawn into the first compartment 241 of the interior space 240 (in a generally horizontal direction), where the airflows 600a, 600b are divided along paths that feed the fan 470 at the upper inlet 472a (positioned on the top of the fan 470) and the lower inlet 472b (positioned on the bottom of the fan 470). Each airflow 600a, 600b is drawn into the inlet 472 in a generally vertical direction, and is discharged from the outlet 474 along an airflow 601a, 601b that moves in a generally horizontal direction approximately perpendicular to the generally vertical direction of the flow paths at each inlet 472. An example of such air movement is schematically illustrated in FIG. 5.

The upper inlets 472a are positioned at a location that has an elevation that is approximately equal to (or that is above) the top-most vertical position of the openings 451 of the intake 456. This may cause airflows 600a to flow along flow paths that extend vertically and around respective fan housings 471 to enter the upper inlet 472. The airflows 600a moving between the intake 456 and the upper inlets 472a move along a portion of the platen surface 211 to provide cooling airflow there along. In another embodiment, the platen surface 211 does not extend over the first compartment 241, and therefore airflows 600a may not provide cooling airflow to the platen surface 211. Electronics, such as control/power electronics 300 (which includes a printed circuit board 305 and circuit components such as capacitors 306) may only be positioned in the second compartment 242 (see e.g., FIG. 8), and therefore airflows 600a, 600b may not provide cooling airflow to the electronics. Alternatively, in another embodiment, electronics such as control/power electronics 300 may be positioned in the first compartment 241, and therefore airflows 600a, 600b may provide cooling airflow to the electronics. In a further embodiment, a portion of the induction coil 110 may be disposed within the first compartment 241, and the cooling system 400 may be configured to provide cooling airflows 600a along paths adjacent to the induction coil 110 to provide cooling air there along.

The lower inlets 472b are positioned at a location that has an elevation that is lower than the bottom-most vertical position of the openings 451 of the intake 456. For example, the lower inlets 472b are positioned at a location that has an elevation that is at approximately 40% of the vertical distance in-between the lower wall 220 and the bottom-most vertical position of the openings 451 of the intake 456. However, the lower inlets 472b may be positioned at a location that has any other elevation in relation to the openings 451 and/or the lower wall 220. Airflows 600b flow along flow paths that extend between the intake 456 and the lower inlets 472b along the lower wall 220. Airflows 600b may also include a vertical component around the respective fan housings 471 and into the lower inlets 474b.

The airflows 601 discharged at the outlets 474 are directed generally horizontally into the second compartment 242 of the interior space 240. In some embodiments, the outlets 474 are dimensioned to provide airflows 601 that move along flow paths that broaden or expand to provide wider discharge paths than the width of the outlets 474. For example, the outlets 474 may be dimensioned to be smaller in horizontal length than the vent 458 (and/or one or more of the two sets of openings 453, 455 of the vent 458), causing the flow paths of the airflows 601 to horizontally broaden as they travel towards the vent 458. These wide flow paths may provide cooling airflows across the control/power electronics 300. In some embodiments, the airflows 601 may also include flow paths that broaden or expand vertically to increase the proximity of the airflows 601 to surfaces of the control/power electronics 300/302, the induction coil 110, the platen surface 211 of the upper assembly 200, or any combination thereof. For example, the outlets 474 may be dimensioned to be smaller in vertical length than the vent 458 (and/or one or more of the two sets of openings 453, 455 of the vent 458), causing the flow paths of the airflows 601 to vertically broaden as they travel towards the vent 458. In some embodiments, additional turbulence may be created along overlapping portions of the airflows 601 or along portions of the sidewall 230 that are adjacent to the vent 458. Such turbulent airflows within the second compartment 242 may also provide additional airflows 601 along the induction coil 110, the platen surface 211 of the upper assembly 210, or both.

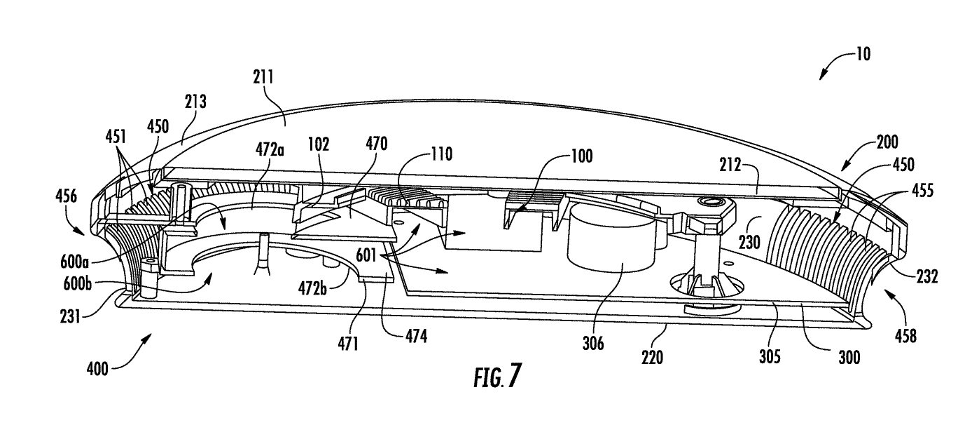

In some embodiments, the control/power electronics 300 (e.g., a circuit board) being cooled by the airflows 601 may be thermally connected to one or more heat sinks 308, as is illustrated in FIGS. 9A-11. A heat sink 308 may be any structure that transfers heat from the control/power electronics 300 to a fluid medium (such as airflows 601), so that the heat may be dissipated away. In some examples, the heat sink 308 may allow regulation of temperature of the control/power electronics 300 at (or near) an optimal level.

The heat sink 308 may have any configuration for transferring heat. For example, as is illustrated, the heat sink 308 may have a series of fins 310 that extend from a base of the heat sink 308 (or from the control/power electronics 300, themselves). The fins 310 may extend upward to any height. By extending upward, successive fins 310 may create channels 312. The fins 310 may create any number of channels 312, and the channels 312 may have any size and/or shape (or other dimension). In some examples, the channels 312 may be oriented to run parallel (or generally parallel) to the airflows 601, as is illustrated in FIGS. 9A-11. Such an orientation may increase the surface area of the heat sink 308 over which the airflows 601 may flow, thereby increasing the amount of heat dissipated by the airflows 601. In other examples, the channels 312 may be oriented to run at any other angle (including perpendicular) with respect to the airflows 601.

The heat sink 308 may be made of any material for transferring heat. For example, the heat sink 308 may be made of aluminum, copper, an aluminum alloy, a copper alloy, diamond, composite materials, any other material for transferring heat, or any combination of the preceding.

The heat sink 308 may be thermally connected to the control/power electronics 300 in any manner. For example, the heat sink 308 may be attached to a portion of the control/power electronics 300 using, for example, an epoxy, wire form z-clip(s), clip-on(s), push pin(s) with compression spring(s), stand-off(s) with compression spring(s), or any combination of the preceding. As another example, the heat sink 308 may be a casing that encapsulates all or a portion of the control/power electronics 300.

The outlets 474 of the fans 470 may be located at any position with respect to the heat sink 308. For example, as is illustrated in FIGS. 9A-11, the outlets 474 of the fans 470 may be positioned adjacent to the heat sink 308. In such an example, there may be no (or a minimal gap) in-between the end of the outlet 474 of a fan 470 and the start of the heat sink 308. In some examples, this may cause the airflows 601 discharged from the outlets 474 to immediately contact a portion of the heat sink after exiting the outlet 474. In other examples, the outlets 474 of the fans 470 may not be positioned adjacent to the heat sink 308, which may cause the airflows 601 to flow over a gap before contacting a portion of the heat sink 308. The gap in-between the outlets 474 and the heat sink 308 may have any size, such as approximately 0.5 inches (e.g., 0.5 inches+/−0.2 inches), approximately 0.75 inches, approximately 1 inch, approximately 1.5 inches, approximately 2 inches, or any other size.

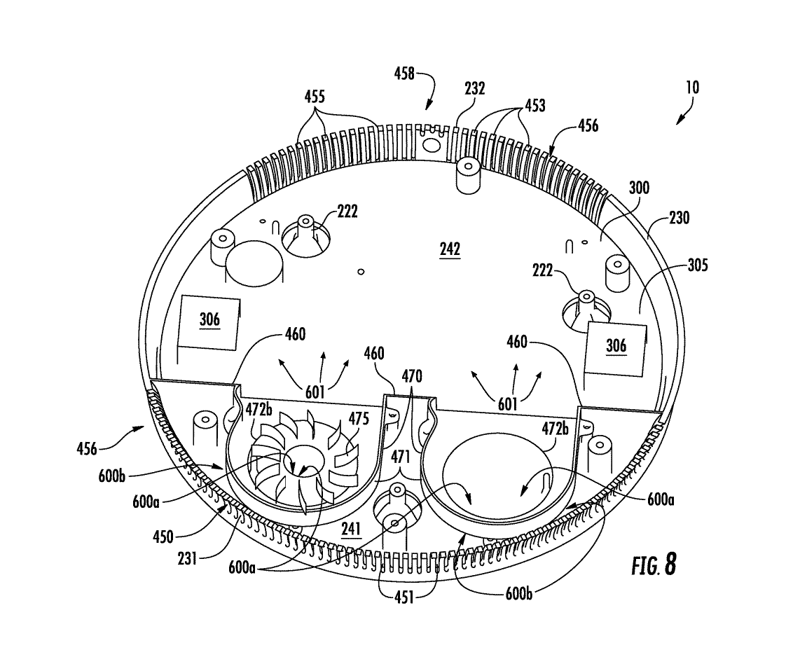

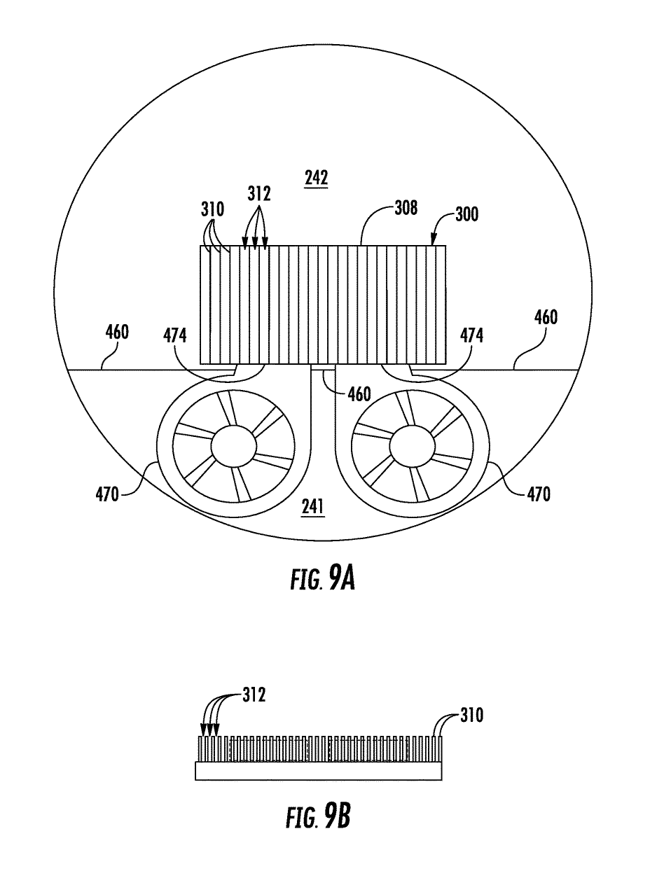

Any number of fans 470 may be positioned to discharge airflows 601 onto (or through) a heat sink 308. For example, as is illustrated in FIGS. 9A, 9B, and 11, two fans 470 may discharge airflows 601 onto (or through) a heat sink 308. As another example, a single fan 470 may be positioned to discharge airflows 601 onto (or through) a heat sink 308. An example of this is illustrated in FIGS. 10A-10B, which illustrates a first fan 470a discharging airflows 601 onto (or through) a first heat sink 308a, and a second fan 470b discharging airflows 601 onto (or through a second heat sink 308b. As another example, a single fan 470 may be positioned to discharge airflows 601 onto (or through) more than one heat sink 308, such as two heat sinks 308, three heat sinks 308, four heat sinks 308, five heat sinks 308, or any other number of heat sinks 308. As a further example, more than two fans 470 may discharge airflows 601 onto (or through) a single heat sink 308, such as three fans 470, four fans 470, five fans 470, or any other number of fans 470.

When more than one fan 470 is positioned to discharge airflows 601 onto (or through) a single heat sink 308, the outlet 474 of each fan 470 may be located at any position with respect to each other. For example, the outlets 474 may be positioned adjacent to each other, as is illustrated in FIGS. 9A-9B. In such an example, the outlets 474 may be positioned so as to be, for example, approximately 0.2 inches (e.g., 0.2 inches+/−0.19 inches) from each other, approximately 0.3 inches from each other, approximately 0.4 inches from each other, approximately 0.5 inches from each other, or any other distance in-between 0 inches and 0.7 inches from each other. As another example, the outlets 474 may be positioned to not be adjacent to each other, as is illustrated in FIG. 11. In such an example, the outlets 474 may be positioned so as to be, for example, approximately 1 inches (e.g., 1 inch+/−0.2 inches) from each other, approximately 1.5 inches from each other, approximately 2 inches from each other, approximately 3 inches from each other, or any other distance greater than 0.7 inches.

Modifications, additions, or omissions may be made to the induction cooking device 10 and/or cooling system 400 of FIGS. 1-11 without departing from the scope of the disclosure. As a first example of such modifications, although the cooling system 400 has been described above as being included in an induction cooking device 10, the cooling system 400 may be included in any other cooking device, such as a cooking device that uses a flame for thermal conduction and/or that uses an electrical heating element or any other heating element for thermal conduction.

As a second example of such modifications, although the intake 456 is described as being positioned in a forward portion of the sidewall 230 and the vent 458 is described as being positioned in a rearward portion of the sidewall 230, the intake 456, the vent 458, and/or the openings 450 may be positioned in any other location(s) of the induction cooking device 10. In various embodiments, the cooling system 400 may be rotated such that the intake 456 extends along a first lateral side of the sidewall 230 and the vent 458 extends along a second lateral side of the sidewall 230. This positioning may cause the bulk of the airflow through the interior space 240 to be oriented horizontally and laterally with respect to the forward and rear orientation of the induction cooking device 10. In one embodiment, the intake 456 or one or more openings 451 thereof may be formed in the lower wall 220 within the first compartment 241. In such embodiments, the fans 470 may be radial fans that draw airflow 600 into the first compartment 241 vertically from below the lower wall 220. In various embodiments, the vent 458 or one or more openings 450 of the vent 458 may be formed in the lower wall 220 within the second compartment 242.

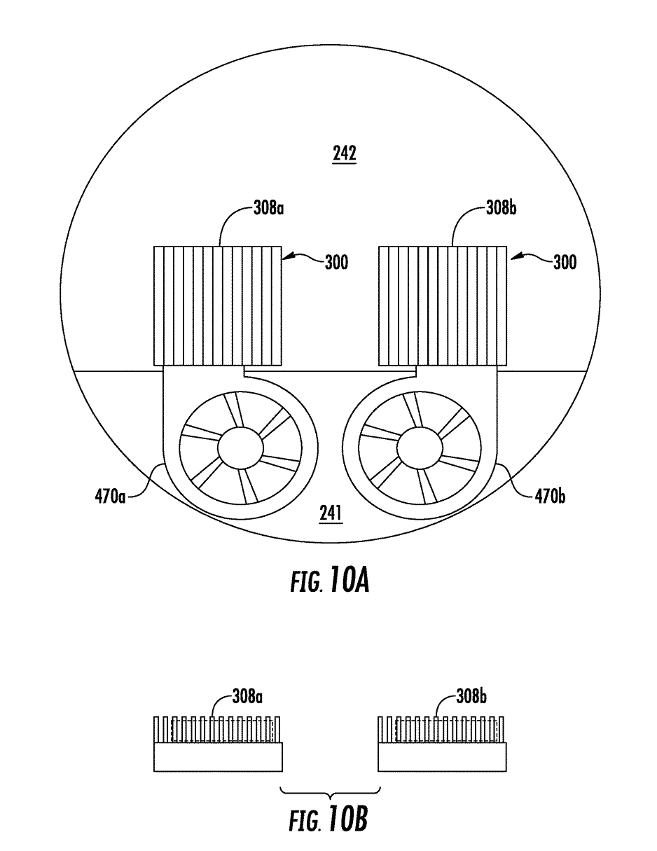

As a third example of such modifications, although the induction cooking device 10 has been described above as having a cross section with a circular or round shape (or a generally circular or round shape), the induction cooking device 10 (and one or more components of the induction cooking device 10) may have a cross section having any other shape, such as a generally rectangular shape, square shape, oval shape, regular polygon shape, irregular polygon shape, or any other shape. As an example of this, FIGS. 12-14 illustrate example induction cooking devices 10 having a cross section that is generally rectangular (e.g., it is rectangular but has one or more curved edges). As is illustrated, the intake 456 is positioned on the curved portion of the sidewall 230, while the vent 458 is positioned on all or a portion of each of the remaining sides of the sidewall 230. Such an induction cooking device 10 may have one fan 470 (such as one centrifugal fan 470, as is illustrated in FIG. 13), two fans 470 (such as two centrifugal fans 470, as is illustrated in FIG. 14), or any other number of fans 470. In some examples, the shape of the induction cooking device 10 of FIGS. 12-14 may allow the induction cooking device 10 to have more than one burner (e.g., assembly 100/induction coil 110), such as two burners.

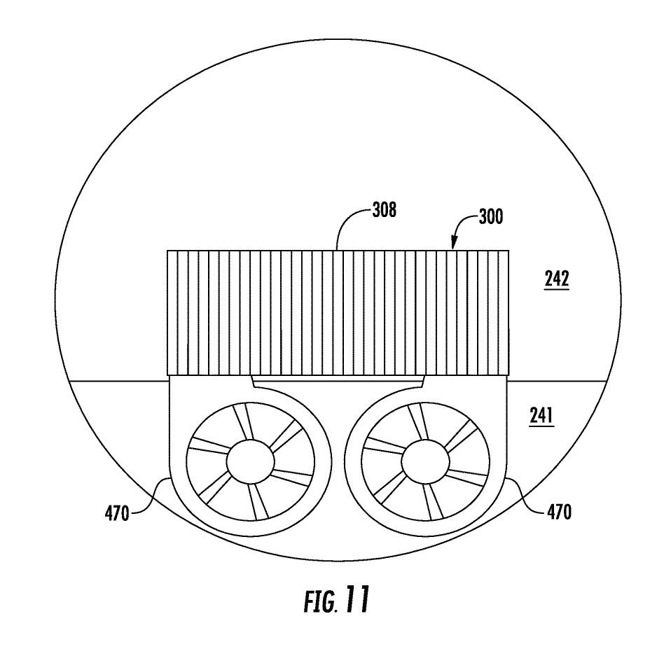

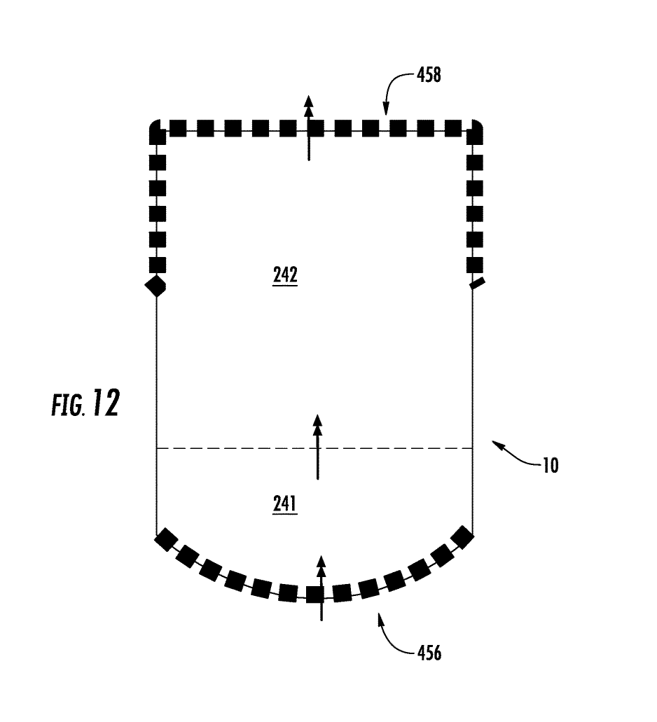

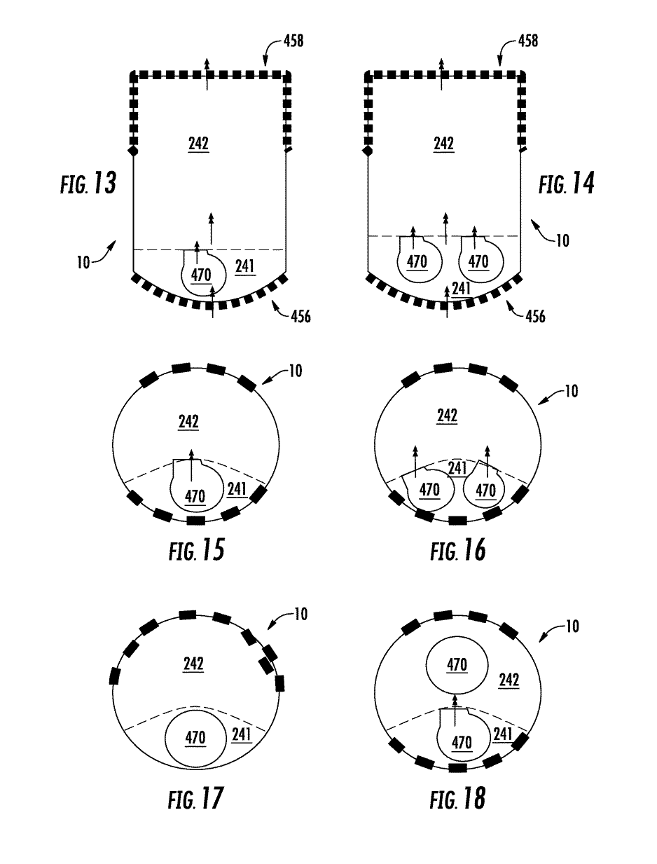

As a fourth example of such modifications, although the induction cooking device 10 has been described above in FIGS. 9A-11 as having one or more centrifugal fans 470 (further examples of which are seen in FIGS. 15-16), the induction cooking device 10 may have any other types of fans 470, such as one or more radial fans that draw airflows into the induction cooking device 10 through the bottom of the induction cooking device 10, or a combination of fans 470. As an example of this, FIG. 17 illustrates an example induction cooking device 10 having a radial fan 470 positioned within the first compartment 241, where the radial fan 470 draw airflows into the induction cooking device 10 through the bottom of the induction cooking device 10. As another example of this, FIG. 18 illustrates an example induction cooking device 10 having a centrifugal fan 470 positioned within the first compartment 241, and a radial fan 470 positioned within the second compartment 242, where the radial fan 470 draw airflows into the induction cooking device 10 through the bottom of the induction cooking device 10.

As a fifth example of such modifications, although the induction cooking device 10 has been described above in FIGS. 9A-11 as being a portable (or countertop) induction cooking device 10, in some examples, the induction cooking device 10 may be a built-in appliance. Such a built-in appliance may be a heavy device (such as a standalone cooking oven and stove) that is, for example, positioned in a horizontal gap between two countertops. As another example, such a built-in appliance may be device (such as a stove top or countertop range) that is lowered into a countertop, so as to be flush (or generally flush) with the countertop. Such a built-in appliance is intended to have all components other than the platen and the control or status indicators mounted below the countertop. This may result in the cooling system and electronic components being positioned below the countertop. In some examples, by being inserted into a counter top, a built-in appliance may have generous space for electronic and electrical components, including cooling fans. Further, although a power cord and plug may be used, built in appliances are frequently hardwired to a junction box in either the device, or the wall below the countertop.

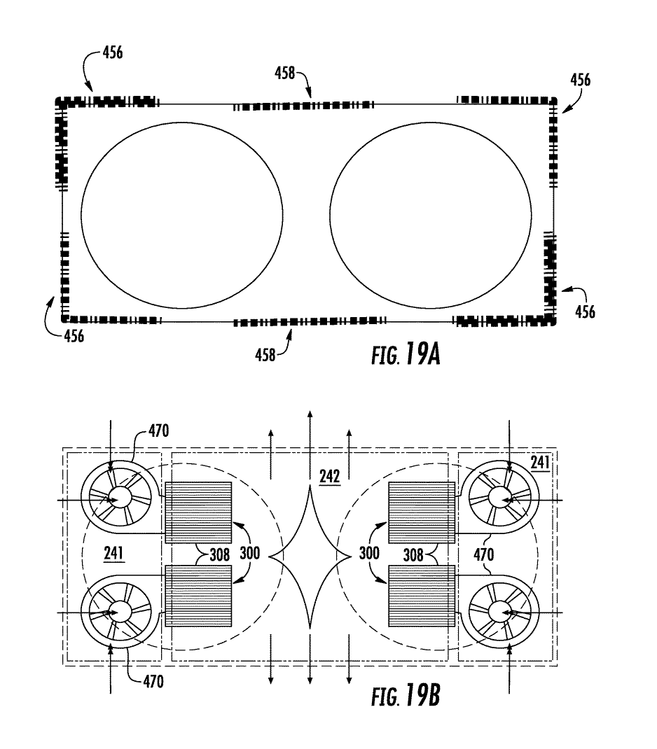

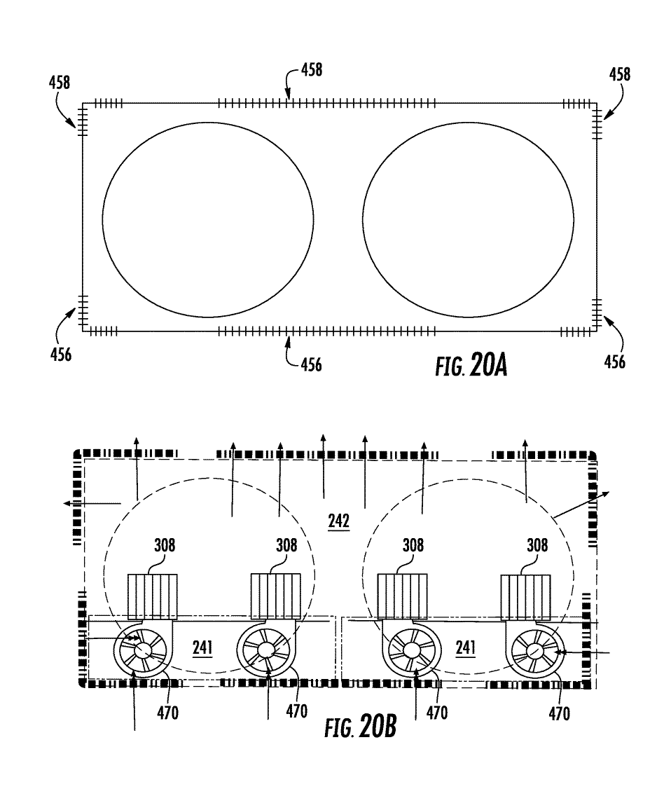

Examples of a built-in induction cooking device 10 are illustrated in FIGS. 19A-20B. As is illustrated, the built-in induction cooking device 10 includes two burners (e.g., assembly 100/induction coil 110), but may include any other number of burners, such as one burner, two burners, three burners, four burners, five burners, six burners, or any other number of burners. Additionally, as is illustrated, the built-in induction cooking device 10 includes two fans 470 and two heat sinks 308 for each burner, but may include any other number of fans 470 and/or heat sinks 308 for each burner. Also, similar to the portable induction cooking device 10, the built-in induction cooking device 10 may include a housing 200 that includes a sidewall 230 (and various other housing components discussed above). Generally, this housing 200 may be configured as a stand-alone device (in the case of, for example, a stand-alone appliance) or as a case or chassis configured for insertion into a dedicated frame or aperture formed in a counter top or table (in the case of, for example, a stove top range). Also, although the induction cooking devices 10 of FIGS. 19A-20B are described herein as examples of a built-in induction cooking device, in some examples, the induction cooking devices 10 of FIGS. 19A-20B may be portable (or countertop) induction cooking devices.

As is illustrated in FIG. 19A, the built-in induction cooking device 10 may include intakes 456 positioned in the sidewall 230 in a location at or near the corners of the built-in induction cooking device 10, and may further include vents 458 positioned in the sidewall 230 in a location at or near the mid-point of the length of the built-in induction cooking device 10. The intakes 456 may draw air into the built-in induction cooking device 10 through the side (e.g., approximately horizontal), and the vents 458 may discharge air from the built-in induction cooking device 10 through the side (e.g., approximately horizontal). In some examples, this may allow the built-in induction cooking device 10 to have a low profile, so as to maximize space below the built-in induction cooking device 10 (such as space in cabinets below the device).

As is illustrated in FIG. 19B, the air drawn into the built-in induction cooking device 10 through the intakes 456 may be further drawn into fans 470 (such as centrifugal fans), and discharged from the fans 470 over (or through) heat sinks 308 so as to cool the control/power electronics 300. The cooling air may then redirected by a structure (such as a redirector), so as to be discharged out of the built-in induction cooking device 10 through the vents 458.

As another example (and as is illustrated in FIGS. 20A-20B), the built-in induction cooking device 10 may include intakes 456 positioned in the sidewall 230 on a first side of the built-in induction cooking device 10, and may further include vents 458 positioned in the sidewall 230 on an opposing side of the built-in induction cooking device 10. The air drawn into the built-in induction cooking device 10 through the intakes 456 may be further drawn into fans 470 (such as centrifugal fans), and discharged from the fans 470 over (or through) heat sinks 308 so as to cool the control/power electronics 300. The cooling air may flow to the opposing side of the built-in induction cooking device 10, where it is discharged out of the built-in in induction cooking device 10 through the vents 458.

As a sixth example of such modifications, any of the components and/or functions described above with regard to any of the embodiments of FIGS. 1-20B may be added to, removed from, and/or substituted for any of the components and/or functions described above with regard to any of the other embodiments of FIGS. 1-20B.

The grammatical articles “one”, “a”, “an”, and “the”, as used in this specification, are intended to include “at least one” or “one or more”, unless otherwise indicated. Thus, the articles are used in this specification to refer to one, or more than one (i.e., to “at least one”) of the grammatical objects of the article. By way of example, “a component” means one or more components, and thus, possibly, more than one component is contemplated and may be employed or used in an application of the described embodiments. Further, the use of a singular noun includes the plural, and the use of a plural noun includes the singular, unless the context of the usage requires otherwise. Additionally, the grammatical conjunctions “and” and “or” are used herein according to accepted usage. By way of example, “x and y” refers to “x” and “y”. On the other hand, “x or y” refers to “x”, “y”, or both “x” and “y”, whereas “either x or y” refers to exclusivity.

This disclosure describes various elements, features, aspects, and advantages of various embodiments, configurations, and arrangements of the systems, apparatuses, and methods thereof. It is to be understood that certain descriptions of the various embodiments and such configurations and arrangements thereof have been simplified to illustrate only those elements, features, and aspects that are relevant to a more clear understanding of the disclosed embodiments, while eliminating, for purposes of brevity or clarity, other elements, features and aspects. Any references to “various,” “certain,” “some,” “one,” or “an” when followed by “embodiment,” “example,” “configuration,” or “arrangement” generally means that a particular element, feature, or aspect described in the example is included in at least one embodiment. The phrases “in various,” “in certain,” “in some,” “in one,” or “in an” when followed by “embodiment”, “example,” “configuration,” or “arrangement” may not necessarily refer to the same embodiment. Furthermore, the phrases “in one such” or “in this” when followed by “embodiment,” “example,” “configuration,” or “arrangement,” while generally referring to and elaborating upon a preceding embodiment, is not intended to suggest that the elements, features, and aspects of the embodiment introduced by the phrase are limited to the preceding embodiment; rather, the phrase is provided to assist the reader in understanding the various elements, features, and aspects disclosed herein and it is to be understood that those having ordinary skill in the art will recognize that such elements, features, and aspects presented in the introduced embodiment may be applied in combination with other various combinations and sub-combinations of the elements, features, and aspects presented in the disclosed embodiments. It is to be appreciated that persons having ordinary skill in the art, upon considering the descriptions herein, will recognize that various combinations or sub-combinations of the various embodiments and other elements, features, and aspects may be desirable in particular implementations or applications. However, because such other elements, features, and aspects may be readily ascertained by persons having ordinary skill in the art upon considering the description herein, and are not necessary for a complete understanding of the disclosed embodiments, a description of such elements, features, and aspects may not be provided. For example, induction cooking devices described herein may also include connections such as fittings for one or more of electrical connections. As such, it is to be understood that the description set forth herein is merely exemplary and illustrative of the disclosed embodiments and is not intended to limit the scope of the invention as defined solely by the claims.

What is claimed is:

1. A portable induction cooking device, the device comprising:
a generally cylindrical housing having a generally circular top platen surface for supporting a cooking vessel, a bottom wall, and a sidewall defining an interior space, wherein the interior space comprises a first portion and a second portion of the interior space separated by one or more baffles;
the second portion of the interior space being disposed adjacent to the first portion of the interior space, wherein the platen surface extends over the first and second portions of the interior space;
the sidewall comprising a first portion extending along the first portion of the interior space and a second portion extending along the second portion of the interior space;
an intake comprising one or more openings extending through the first portion of the sidewall between the first portion of the interior space and an external environment;
a vent comprising one or more openings extending through the second portion of the sidewall between the second portion of the interior space and the external environment;
one or more fans positioned in the interior space, wherein each of the one or more fans includes an inlet positioned in the first portion of the interior space and an outlet positioned in the second portion of the interior space, wherein the inlet draws air into the fan in a first generally vertical direction, wherein the outlet discharges air out of the fan in a first generally horizontal direction, wherein the one or more fans are configured to draw air into the housing through the intake in a second generally horizontal direction and are further configured to discharge air out of the housing through the vent in a third generally horizontal direction;
at least one induction coil disposed below the platen surface;
electronics for modulating the power of the at least one induction coil, the electronics being positioned in the second portion of the interior space, at least a portion of the electronics being thermally connected to a heat sink having a series of vertical fins that define channels, the channels being positioned approximately parallel to the air discharged from the respective outlet of at least one of the one or more fans, the heat sink being positioned adjacent to the respective outlet of the at least one of the one or more fans; and
wherein the device weighs less than 15 pounds.

2. A portable induction cooking device, the device comprising:
a housing having a top platen surface for supporting a cooking vessel, a bottom wall, and a sidewall defining an interior space, wherein the interior space comprises a first portion and a second portion of the interior space separated by one or more baffles;
an intake comprising one or more openings extending through the sidewall between the first portion of the interior space and an external environment;
a vent comprising one or more openings extending through the sidewall between the second portion of the interior space and the external environment;
one or more fans positioned in the interior space, wherein each of the one or more fans includes a first inlet positioned in the first portion of the interior space and a first outlet positioned in the second portion of the interior space, wherein the first inlet draws air into the fan from the first portion of the interior space and the first outlet discharges air out of the fan into the second portion of the interior space, wherein the one or more fans are configured to draw air into the housing through the intake in a first generally horizontal direction and are further configured to discharge air out of the housing through the vent in a second generally horizontal direction;
at least one induction coil disposed below the platen surface; and
electronics for modulating the power of the at least one induction coil, the electronics being positioned in the second portion of the interior space.

3. The device of claim 2, wherein the device weighs less than 15 pounds.

4. The device of claim 2, wherein the device weighs less than 5 pounds.

5. The device of claim 2, wherein the first inlet of each of the one or more fans draws air into the fan in a generally vertical direction.

6. The device of claim 2, wherein the first inlet of each of the one or more fans draws air into the fan in a third generally horizontal direction.

7. The device of claim 2, wherein each of the one or more fans further includes a second inlet positioned in the first portion of the interior space, wherein the first inlet is positioned on a top wall of the respective fan and draws air into the respective fan in a first generally vertical direction, wherein the second inlet is positioned on a bottom wall of the respective fan and draws air into the respective fan in a second generally vertical direction.

8. The device of claim 2, wherein the first outlet of each of the one or more fans is positioned on a sidewall of the respective fan and discharges air out of the respective fan in a third generally horizontal direction.

9. The device of claim 2, wherein at least a portion of the electronics are thermally connected to a heat sink.

10. The device of claim 9, wherein the heat sink has a series of vertical fins that define channels, the channels being positioned approximately parallel to the air discharged from the first outlet of at least one of the one or more fans.

11. The device of claim 10, wherein the heat sink is positioned adjacent to the first outlet of the at least one of the one or more fans.

12. The device of claim 2, wherein the housing has a cross-sectional shape that is generally circular, generally rectangular, generally oval, or generally square.

13. The device of claim 2, wherein the vent is positioned on the sidewall in a location that is opposite of a location of the intake.

14. The device of claim 2, wherein the size of the intake is at least 30% of the size of a combination of the first inlet and any other inlet of a respective fan of the one or more fans.

15. The device of claim 2, wherein the size of the intake is at least 45% of the size of a combination of the first inlet and any other inlet of a respective fan of the one or more fans.

16. A method of cooling a portable induction cooking device, the portable induction cooking device comprising a housing that defines an interior space separated into a first portion and a second portion, wherein the first portion includes one or more intake openings extending through a sidewall of the housing and a first inlet of each of one or more fans, and wherein the second portion includes one or more vent openings extending through the sidewall of the housing and a first outlet of each of the one or more fans, the method comprising:
drawing airflow into the first portion through the one or more intake openings in a first generally horizontal direction;
drawing airflow into each of the one or more fans through the respective first inlet in a first generally vertical direction;
discharging airflow into the second portion out of each of the one or more fans through the respective first outlet in a second generally horizontal direction, and cooling electronics for modulating an induction coil of the portable induction cooking device using at least a portion of the airflow discharged into the second portion; and
further discharging airflow out of the second portion through the one or more vent openings in a third generally horizontal direction.

17. The method of claim 17, wherein cooling the electronics comprises passing the airflow discharged into the second portion over at least a portion of a heat sink thermally connected to a portion of the electronics.

18. The method of claim 17, wherein each of the one or more fans further includes a second inlet, and wherein the method further comprises drawing airflow into each of the one or more fans through the respective second inlet in a second generally vertical direction.

19. The method of claim 17, wherein the portable induction cooking device weighs less than 15 pounds.

20. The method of claim 17, wherein the portable induction cooking device weighs less than 5 pounds.
